(19) United States
(12) Patent Application Publication
(10) Pub. No.: US 2009/0047016 A1
(43) Pub. Date: Feb. 19, 2009

(54) Multi-access network terminal, communication method, service-providing method, and revenue-receiving method

(75) Inventors: Marc R. Bernard, Miramar, FL (US); Douglas A. Atkinson, Ashburn, VA (US); Guy M. Merritt, Purcellville, VA (US); Timothy J. Doiron, Aurora, IL (US)

Correspondence Address: FITZPATRICK CELLA (TELLABS), 30 ROCKEFELLER PLAZA, NEW YORK, NY, 10112-3800, US

(73) Assignee: Tellabs Vienna, Inc., Naperville, IL (US)

(21) Appl. No.: 11/889,381

(22) Filed: Aug. 13, 2007

(51) Int. Cl. H04J 14/00

(52) U.S. Cl. 398/43

(57) ABSTRACT

A multi-access network terminal includes first and second communication interfaces. The first interface is configured to communicate with a first service provider providing services to a user through the first interface with a first type of signal and/or a first type of communications protocol. The second interface is configured to communicate with the first service provider providing services to the user through the second communication interface using a second type of signal and/or a second type of communications protocol. Alternatively, the second interface is configured to communicate with a second service provider providing services to the user through the second communication interface using the first or second type of signal and/or the first or second different type of communications protocol.

### BACKGROUND OF THE INVENTION

1. Field of the Invention

This invention relates to the field of network communications. More specifically, the invention relates to wired and wireless data, video, and audio communications provided to a customer by a network communication service provider, and to a business method of determining the flow of revenues generated by such services.

2. Description of Related Art

Traditional wireline networks provide telephone, data, video, and other services through one or more optical network terminals (ONTs). But these services can be interrupted by the malfunctioning of any of the components of the network, such as the optical line terminal and the optical fiber itself, and by a power outage. Such a service interruption may be a local problem, caused, for example, by a cut optical fiber, which affects a few customers, or a large-scale problem caused, for example, by a power outage in an entire neighborhood or region. When the interruption in service is due to a local power outage, a battery back-up module attached to the optical network terminal on the customer's premises (or integrated into the ONT for on-demand power) can restore service. But the battery back up typically provides power for only an additional eight to twelve hours. If the local power outage lasts longer than the battery, service will again stop. On the other hand, a power outage may affect the entire network. In this case, the battery back-up will be ineffective in restoring service. Therefore, it would be useful for the customer to have access to a back-up network to provide, on demand, one or more of the services provided by the primary wireline network. Such access would be particularly helpful in an emergency.

Similarly, wireless networks, such as direct broadcast satellite networks and WiMAX networks, can suffer power outages, interrupting service to the customer. In this case also, it would be useful for the customer to have access to an on-demand, back-up network to provide one or more of the services provided by the wireless service provider.

Another situation in which a back-up network would be helpful, occurs in locations in which a communications service provider has not yet deployed fiber optic cable, but would like to offer service immediately. In this case, it would be advantageous for the service provider to employ a wireless system to which the customer has access through a device that can also connect to a wireline system. As a result, once the fiber optic cable has been deployed, wireline services can be easily activated to roll out fiber-to-the-premises (FTTP) services, for example.

Still another problem can be solved by employing a device permitting two different networks to work closely together in delivering communications services to the customer: service providers of one kind of service (such as wireless communication) find it desirable to offer customers another type of service (such as wireline communications), but do not own the infrastructure to offer that additional service. This problem arises because in some localities, different service providers own different types of networks, and many customers want to access the services on both networks, but also want the convenience of dealing with one vendor. Moreover, simply bundling the services of two networks together results in the installation and maintenance of two completely different sets of equipment for the two networks, which can be burdensome for both the service providers and the customer. Thus, there is a need for a single device that connects to different networks of different service providers to facilitate bundling of network services.

### SUMMARY OF THE INVENTION

One or more of the foregoing problems can be solved by a multi-access network terminal (MANT) comprising first and second communication interfaces. The first communication interface can be configured to communicate with a first service provider providing services to a user through the first communication interface with a first type of signal and/or a first type of communications protocol. The second communication interface can be configured to communicate with either the first service provider providing services to the user through the second communication interface using a second type of signal and/or a second type of communications protocol or a second service provider providing services to the user through the second communication interface using the first or second type of signal and/or the first or second different type of communications protocol.

One or more of the foregoing problems can also be solved by a multi-access network terminal connectable to multiple service termination devices provided in a particular location. The terminal can comprise first and second communication interfaces. The first communication interface can be configured to connect with at least one of the service termination devices provided in the particular location and to communicate with a first service provider providing services to the service termination device connected to the first communication interface. The second communication interface can be configured to connect with the same or a different one of the service termination devices and to communicate with a second service provider providing services to the service termination device connected to the second communication interface.

In addition, one or more of the foregoing problems can also be solved by a communication method comprising routing signals providing communication between at least one termination device of a user and a first service provider through a first communication interface of a multi-access network terminal, the signals being of a first type and/or the communication following a first type of communication protocol. The method also includes the performing at least one of two routing operations. One routing operation routes signals providing communication between at least the same or a different termination device of the user and the first service provider through a second communication interface of the multi-access network terminal. The signals routed through the second communication interface are of a second type and/or the communication through the second communication interface follows a second type of communication protocol. The other routing operation routes signals through the second communication interface providing communication between the same or a different termination device of the user and a second service provider that uses the first type of signal or the second type of signal for communication with the termination device and/or that uses the first type of or the second type of communications protocol for communication with the termination device.

In addition, one or more of the foregoing problems can also be solved by a method of providing services to a user comprising generating signals by a first service provider for transmission to a service termination device of a user, and routing the signals from the first service provider to the service termination device through a multi-access network terminal through which a second service provider transmits signals to the same or a different service termination device of the user.

Further, one or more of the foregoing problems can also be solved by a method of managing the flow of revenue for services rendered by a service provider through a multi-access network terminal comprising routing signals from a first service provider to a service termination device of a user through the multi-access network terminal through which a second service provider transmits signals to the same or a different service termination device of the user, and receiving by the first service provider a first revenue from the user for services rendered by the first service provider through the multi-access network terminal.

### BRIEF DESCRIPTION OF THE DRAWINGS

FIG. 1 is a schematic diagram of an example embodiment of a multi-access network terminal and the environment in which it is deployed.

FIG. 2 is a schematic block diagram of an example embodiment of the multi-access network terminal.

FIG. 3 is a schematic block diagram of one example embodiment of the relationship between a multi-access network terminal and two service providers.

FIG. 4 is a schematic block diagram of another example embodiment of the relationship between a multi-access network terminal and two service providers.

FIG. 5 is a schematic diagram of one example embodiment of the revenue flow between a subscriber, a first service provider, and a second service provider.

FIG. 6 is a schematic diagram of another example embodiment of the revenue flow between a subscriber, a first service provider, and a second service provider.

FIG. 7 is a flow chart of an example embodiment of a method of routing signals from first and second service providers to a customer through a MANT.

FIG. 8 is a flow chart of an example embodiment of a method of providing services from multiple service providers to a customer through a MANT and of managing revenues generated therefrom.

### DETAILED DESCRIPTION OF THE INVENTION

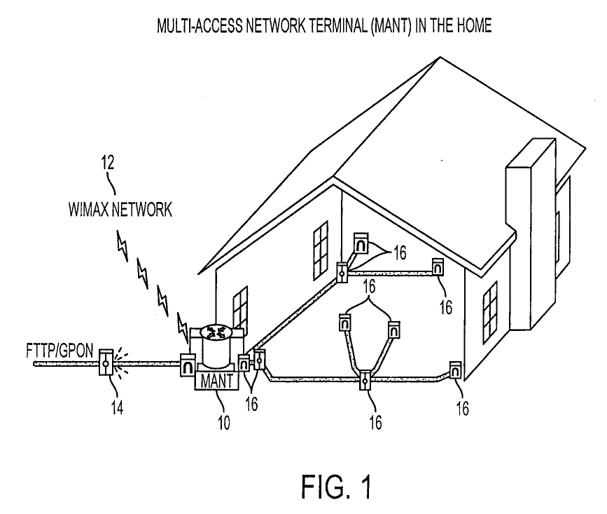

FIG. 1 illustrates one example embodiment of an optical network terminal (ONT) connecting service termination devices in a customer's home to multiple networks. More specifically, the example embodiment shown in FIG. 1 of the optical network terminal comprises a multi-access network terminal 10 used in the home to deliver communication services to a customer. But it should be understood that the invention is not limited to using the multi-access network terminal (MANT) in a customer's home. It is within the scope of the invention for the MANT to be deployed inside or outside any structure for delivering communications services to residential, business, or other customers. The communication services that the MANT 10 can deliver include, but are not limited to wired and wireless data services (such as all kinds of internet and intranet access and services), wired and wireless video services (including all kinds of broadcast, satellite, cable, and internet television, and video services), wired and wireless alarm services, and/or wired and wireless audio services (including all kinds of internet audio and music services and all kinds of wireline and wireless telephone services).

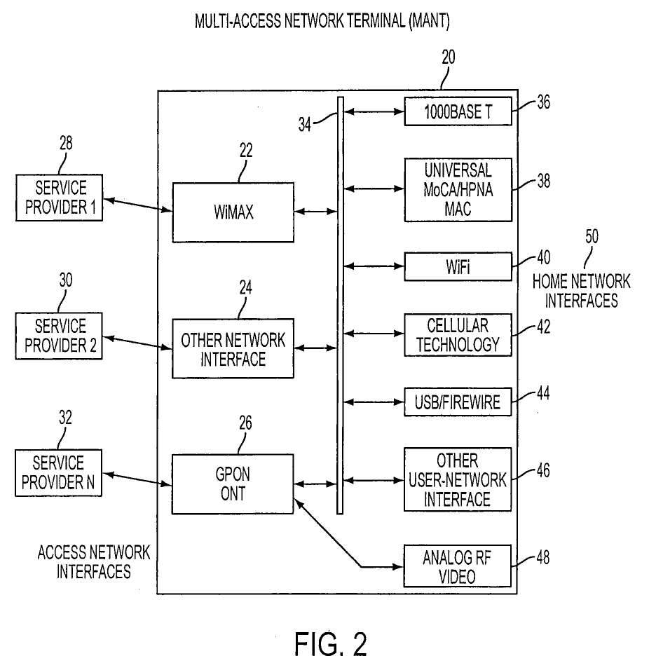

As shown in FIG. 1, the MANT 10 can receive wireless signals from a WiMAX network 12 at one access network interface (not shown in FIG. 1, but shown in FIG. 2). The MANT 10 can also receive wireline optical signals from a Gigabit Passive Optical Network (GPON) 14 that connects to the MANT 10 via fiber optic cable employing a fiber-to-the-premises connection (FTTP) at another access network interface (also not shown in FIG. 1, but shown in FIG. 2). The MANT 10 can be configured to distribute the signals from these networks to various service termination devices 16 in the customer's home. These service termination devices 16 can include, but are not limited to any type of customer alarm system, any type of computer connected to the MANT 10 via any type of Ethernet cable or other type of cable, wireless routers, laptop computers with a wireless card, wired telephones, wireless telephones, session-initiation-protocol (SIP) telephones, voice-over-internet-protocol (VOIP) telephones, and cellular telephones, televisions, cable boxes, cable modems, direct broadcast satellite devices, and an access point base station (femtocell). Each of these devices 16 can be connected to the MANT through a corresponding user port on the MANT, non-limiting examples of which are shown in FIG. 2 and discussed below. For example, cellular telephones can be connected wirelessly to the MANT through a femtocell protocol via an access point base station It should also be understood that the MANT 10 is not limited to receiving a single wired signal and a single wireless signal from a single wired network and a single wireless network over two access network interfaces. The MANT 10 can include more than two access network interfaces and each interface can be connectable to the same or a different physical medium from the other interfaces. And the MANT 10 is not limited to connecting to a WiMAX network and a GPON network. It is within the scope of the invention for the MANT 10 to have access network interfaces to connect to any type of wireline network using any type of wireline protocol and any type of wireless network using any type of wireless protocol. For example, the MANT 10 can include, but is not limited to, wireline network interfaces to connect to any type of passive optical network (non-limiting examples of which include a BPON (Broadband Passive Optical Network), a WDM-PON (Wavelength Division Multiplexing Passive Optical Network), and a GPON (Gigabit PON)), a cable network, a copper wire analog telephone network, and a DSL network. The MANT 10 can also include, but is not limited to, network interfaces to connect to other wireless networks, such as a direct broadcast satellite network, a WiFi network, and a cellular network (for example, a GSM network and a CDMA network). The wired network interfaces can be configured to connect to wired networks following any network protocol, such as, but not limited to, the broadband passive optical network protocol according to the ITU G.983.x standard, the gigabit passive optical network protocol according to the ITU G.984.x standard, the Ethernet passive optical network protocol, the wavelength division multiplexing passive optical network protocol, the cable modem protocol comprising one of the DOCSIS 2.0 protocol and the DOCSIS 3.0 protocol, and the xDSL protocol comprising one of the ADSL ANSI T1.413 Issue 2 protocol, the ITU G.992.1 (G.DMT) protocol, the ITU G.992.2 (G.Lite) protocol, the ADSL2 ITU G.992.3/4 protocol, the ITU G.992.3 Annex J protocol, the ITU G.992.3 Annex L protocol, the ADSL2+ITU G.992.5 protocol, the ITU G.992.5 Annex L protocol, and the ITU G.992.5 Annex M protocol. As a result, the wireline signal can be a wavelength division multiplexed optical signal, a dense wavelength division multiplexed optical signal, or an electrical signal comprising one of a cable modem signal, an analog telephone signal, and an xDSL signal. The wireless network interfaces of the MANT 10 can be configured to connect to wireless networks following any wireless network protocol, such as the WiMAX protocol according to the IEEE 802.16 standards, the WiFi protocol according to the 802.11 standards, the cellular phone protocol comprising the GSM protocol and the CDMA protocol, and the femtocell protocol. As a result, the wireless signal can be a WiMAX signal, a WiFi signal, a cellular phone signal, a direct broadcast satellite signal, or a femtocell signal. It should be understood that the access network interfaces of the MANT 10 are not limited to connecting to these wired and wireless networks and protocols mentioned above, and can include interfaces connectable to other types of wired and wireless networks using any other communications protocols.

In one example embodiment, the MANT 10 can be configured so that the wired network connected to the MANT 10 is the active channel through which network services can be continuously provided to the customer and the wireless network connected to the MANT 10 is a standby channel that provides one or more services provided through the active channel in the event the wired network fails to provide network services to the customer. Alternatively, the wired network can be the standby channel and the wireless network can be the active channel. In still another example embodiment, the MANT 10 can be configured so that the wired network connected to the MANT 10 is an active channel through which network services can be continuously provided to the customer and the wireless network connected to the MANT 10 is also an active channel through which network services can be continuously provided to the customer. More generally, if the MANT 10 contains more than two access network interfaces to more than two networks, the MANT 10 can be configured so that at least one of the networks is a standby channel, or so that all of the networks are active channels.

In one example embodiment, the access network interfaces, which are shown in FIG. 2 and will be discussed in more detail below, can be integrated into the MANT. In another example embodiment, the access interfaces can be attached to the MANT 10 as a dongle or similar device, via, for example, a USB port on the MANT 10. In either case, the MANT 10 can be configured to detect whether signals from the networks connected thereto at the access network interfaces are received thereby. In addition, the MANT 10 can be configured to detect problems on the networks connected thereto that affect the quality of the signals received therefrom. In one example embodiment, the MANT 10 can be configured so that when it detects the absence of a signal on the primary channel or when it detects substantial problems with the quality of the signals received on the primary channel (in this case the signal from the GPON 14), the MANT 10 blocks one or more signals from the GPON 14 from reaching the service termination devices 16 and directs signals from the wireless WiMAX network 12 via its access network interface to the service termination devices 16 to provide one or more of the services previously provided by the GPON network 14. In one example embodiment, the MANT 10 can be configured so that all of the services provided by the GPON network 14 are provided instead by the WiMAX network 12. In another example embodiment, the MANT 10 can be configured so that a subset of all the services provided by the GPON network 14 is provided instead by the WiMAX network 12.

The MANT 10 can also be configured to address the rebooting of a GPON card within the OLT platform of a GPON network 14 offering video-on-demand (VoD) services that does not affect the transmission of the 1550 nm signal. More specifically, the MANT 10 can be configured to permit the user to send upstream requests over the wireless domain via the wireless network 12 (where it will reach the video server in the GPON network 14) instead of waiting for the 1310 nm/1490 nm channels of the GPON network 14 to recover.

In still another example embodiment, the MANT 10 can be configured to switch a wireline voice call over the GPON network 14 to the wireless network 12 when the MANT 10 detects that the 1490 nm and 1310 nm channels are not active on the GPON network 14 during a voice call. And due to a previous arrangement with the wireless network service provider, the wireless network can be configured to route the voice call to reach the same SIP (session initiation protocol) server that would be reached if the voice call had remained on the GPON network 14, or to reach a similar server, so the call will not be interrupted. In other words, the customer will not notice that the call has been switched from the GPON network 14 to the wireless network 12. Similarly, in another example embodiment, the MANT 10 can be configured to switch to the wireless network 12 to carry an alarm signal or alarm phone call when the MANT 10 detects that the 1490 nm and 1310 nm channels are not active on the GPON network 14 and an alarm system connected to one of the user ports of the MANT 10 is triggered.

In addition, where the wireless bandwidth is available (usually requiring the customer to pay for such extra bandwidth), this type of system can even provide a backup channel for video when the wireline network 14 goes down. More specifically, in one example embodiment, the MANT 10 can be configured to switch from transmitting video signals from the fiber network 14 to a television set (which is one of the service termination devices 16) to transmitting video signals from the wireless network 12 (or some other physical access media network connected to the MANT 10) to the television set, but in a lower quality fashion to accommodate the lower bandwidth of the wireless network. For example, suppose that a customer is watching all HDTV streams on the 1490 nm channel on the GPON network 14 while this channel ceases transmission or develops problems substantially affecting the quality of the HDTV signal. This potential interruption in customer service can be due to a rebooting on the GPON network 14 or other problems affecting the quality of the signal. In this case, the MANT 10 can detect the lack of transmission on the 1490 nm channel or the substantial drop in quality on this channel, and switch over to the wireless network 12. In one example embodiment, the MANT 10 can also request or instruct the network 14 to use its GWR/video server in the optical line terminal thereof to re-route all HDTV streams to the wireless network 12. This transfer can be performed in such a manner that all of the HDTV streams are replaced by lower quality streams (such as SDTV or lower quality) or only a few primary streams remain HDTV streams to accommodate the lower bandwidth of the wireless network. In addition, after detecting such transmission problems with the signal on the GPON network 14 and switching to the wireless network 12, the MANT 10 can transmit the lower quality TV signals from the wireless network 12 to the television set or sets in the customer's home via its television user port or ports. Of course, there may be future generations of wireless/WiMAX networks that can accommodate ultra high bandwidth and quality so that channels from these networks can potentially also be HDTV streams and the conversion to lower-quality video would not need to happen in the event that the wireline network develops transmission problems. In addition, for sending video upstream from one of the service termination devices 16 to a network, if the 1310 nm signal in not available in the GPON network 14, in this example embodiment the MANT 10 can be configured to transmit such video signals from one or more of the service termination devices 16 to the wireless network 12 with all the joins and leaves rerouted towards the backup network 12 until the primary network 14 becomes available.

In another example embodiment, both the wireline network 14 and the wireless network 12 may be active channels simultaneously so that different service providers provide simultaneous services to the same subscriber through the MANT 10. In this embodiment, the MANT 10 can be configured to transmit signals from both the network 12 and the network 14 over different access network interfaces thereof at the same time. For example, if both the network 12 and the network 14 provide a-la-carte IPTV, then the MANT 10 can be configured so as to transmit a specific video stream from one service provider (or website connected to a specific access interface) over one interface thereof to one or more of the service termination devices 16, and to transmit a specific video stream from another provider over a different access interface thereof to one or more of the service termination devices 16.

In still another example embodiment, one interface of the MANT 10 can operate at a lower power than the other interface or interfaces, but can still offer sufficient services when powered by battery power of the MANT 10. In this example embodiment, the MANT 10 can be configured to receive signals only from the network connected to the lower power interface when the MANT 10 is operating from battery power due to a loss of AC power. But it should be understood that the MANT 10 is not limited to this option, and it is within the scope of the invention to configure the MANT 10 to connect to a higher power interface when there is a power loss.

In yet another example embodiment, the MANT 10 can be configured/managed initially or throughout its lifetime via the WiMAX network 12. Alternatively, the MANT 10 can be configured/managed via the PON network 14, and in another example embodiment the MANT 10 can be configured/managed by both networks. In still another example embodiment, the same management channel can manage the MANT 10 via either the wireless interface or via the GPON interface, and an element management system (EMS) at each network connected to the MANT 10 can be configured to create the same management channel at both interfaces, or the OLT/GWR of only one network, for example, the GPON network 14, can create a management channel TR-69 through one primary interface on the MANT 10, while the wireless network 12 does not manage the MANT 10 over a management channel. In another example embodiment, one service provider (e.g. Cingular) can configure specific attributes on the MANT 10 via their own management system, and another service provider (e.g. Verizon) can configure other attributes on the MANT 10 via the fiber interface. In this example embodiment, the MANT 10 can be configured to be managed by two different service providers, and can be upgraded by only one predetermined management interface or alternatively can have multiple hosts that are individually upgradeable and manageable.

In another example embodiment, the MANT 10 has a pre-determined number of user ports (not shown in FIG. 1, but shown in FIG. 2) to each of which one of the service termination devices 16 is connected. In this embodiment, both access network interfaces on the MANT 10 can have access to all of the user ports. The user ports can include, but are not limited to voice, data, and video ports, as will be discussed in more detail below in connection a discussion of FIG. 2. As a result, in this example embodiment, the networks 12 and 14 can access all voice, data, and video ports of the MANT 10 and, therefore, the networks can access all voice, data, and video devices that comprise the service termination devices 16. Alternatively, the MANT 10 can be configured so that not all of the access network interfaces on the MANT 10 and not all of the networks connected thereto have access to all the user ports. For example, the MANT 10 can be configured to associate a specific service provider, connected to an associated access network interface of the MANT 10, with one or more specific user ports thereof. Thus, in one non-limiting example embodiment, the MANT 10 can be configured so that 1) signals from a data service provider that provides data services to the customer are routed only to the data user ports of the MANT 10 and the data devices connected thereto, such as computers, 2) analog telephone signals from a POTS telephone service provider are routed only to the POTS user ports of the MANT 10, and 3) cable television signals from a cable television service provider are routed only to the cable television user ports of the MANT 10. In a typical example embodiment, the access network interfaces of the MANT 10 are configured so as not to route/flood/forward traffic between each other. Instead, the MANT 10 can be configured to transmit all traffic received on an access network interface thereof from a network directly to one user port. Alternatively, the MANT 10 can be configured to enable all user ports at all times and to route signal traffic to the best port (i.e., the best port can be determined to be the port with the most bandwidth, the most signal power/line quality, etc.). But it is within the scope of the invention for the access network interfaces of the MANT 10 to route/flood/forward some or all traffic therebetween. In addition, it is within the scope of the invention for the MANT 10 to be configured to route signal traffic from each access network interface to more than one but fewer than all user ports.

In an alternative example embodiment, instead of having a WiMAX interface to connect to the WiMAX network 12, the dongle enabling communication with the WiMAX network 12 can be replaced by a cellular transceiver, permitting the MANT 10 to function as a cellular device, allowing customers within the home to make cellular calls instead of calls routed over the GPON network 14.

FIG. 2 shows an example embodiment of a MANT 20. The MANT 20 can be the same as or different from the MANT 10 shown in FIG. 1. As a result, the MANT 20 can be configured to perform the functions of the MANT 10 shown in FIG. 1, although it is not limited to performing these functions and can perform more than or fewer than the number of functions the MANT 10 can perform. The MANT 20 can comprise three access network interfaces 22, 24, and 26 connectable to service providers 28, 30, and 32, respectively. The access network interface 22 can be a WiMAX interface connectable to a WiMAX network, the access network interface 24 can be another type of network interface connectable to another type of network (either a wired or a wireless network, which can be, but is not limited to, any of the specific types of networks noted above), and the access network interface 26 can be a GPON interface connectable to a GPON network. It is within the scope of the invention for the GPON interface 26 to be the same as or different from the GPON user interface of the MANT 10 shown in FIG. 1. And it is within the scope of the invention for the WiMAX interface 22 to be the same as or different than the WiMAX interface of the MANT 10 shown in FIG. 1. It is also within the scope of the invention for the MANT 20 to include more or fewer than 3 access network interfaces. And it is within the scope of the invention for the access network interfaces 22, 24, and 26 and/or any additional access network interfaces of the MANT 20 to be different types of interfaces than that shown in FIG. 2 that are connectable to other types of networks, such as any of the networks mentioned earlier, or any other communications network. The MANT 20 can also comprise a bus 34 to which the access network interfaces 22, 24, and 26 can be connected. In addition, the MANT 20 can comprise a plurality of user ports, each of which is connectable to a different type of user termination device (which are not shown in FIG. 2 and which can be the same as or different from the user termination devices 16 shown in FIG. 1). The user ports can include but are not limited to a 10/100/1000Base-T user port 36, a Universal MoCA/HPNA MAC (Multi-media over Coax Alliance/Home Phoneline Networking Alliance Media Access Control) user port 38, a WiFi user port 40, one or more voice user ports comprising a local analog user POTS (plain-old-telephone service) port (not shown) and a cellular technology user port 42 permitting a cellular phone to communicate with the MANT 20 via, for example, a femtocell protocol, a USB/Firewire user port 44, any other type of user-network interface port 46, a home-alarm user port (not shown) connectable to the customer's alarm system, and an Analog RF video port 48. These ports collectively comprise the MANT's home network interfaces 50, which connect to the different user termination devices of the user. The access network interfaces 22, 24, and 26 can connect with one or more of the user ports 36, 38, 40, 42, 44, 46, and 48 through the bus 34 in the same manner or a different manner than the access network interfaces of the MANT 10 connect to the user ports thereof. It is within the scope of the invention for the MANT 20 to include fewer user ports than that shown in FIG. 2. It is also within the scope of the invention for the MANT 20 to include additional user ports in addition to those shown in FIG. 2. Those additional user ports can be the same type of user port or can be different types of user ports than those shown in FIG. 2.

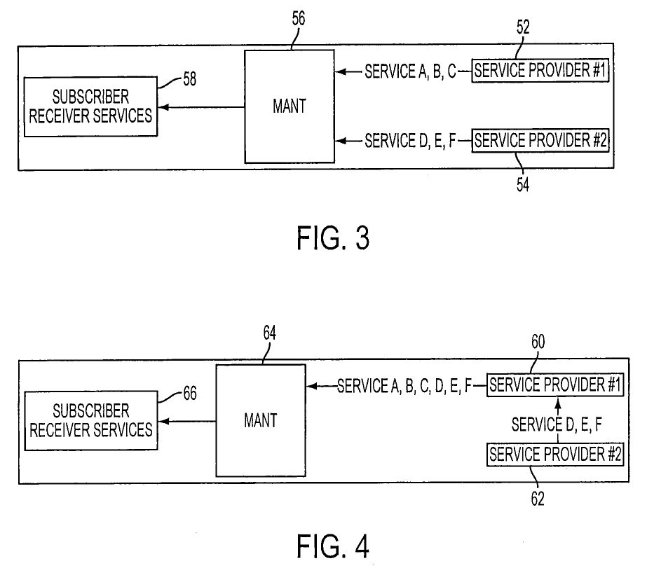

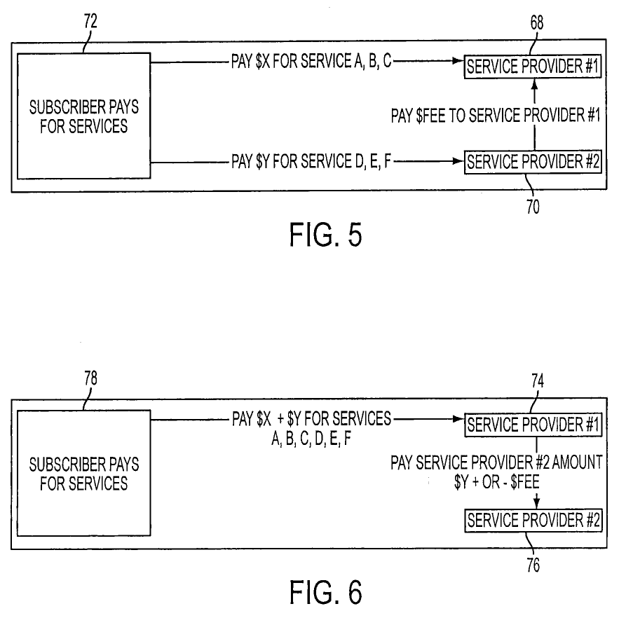

According to other example embodiments, the invention can relate to both a method of providing services to a user through a MANT (FIGS. 3 and 4) and a business method of exchanging funds between customers, called subscribers, and multiple service providers that provide services to the subscribers through a MANT (FIGS. 5 and 6).

In one example embodiment, the MANT (such as, but not limited to the MANTs 10, 20, 56 (shown in FIG. 3), and 64 (shown in FIG. 4)) can be the primary interface to all subscriber services in the home. The MANT can be installed by a technician from a service provider, such as, for example, Verizon. In this case, the technician can connect the MANT to a fiber optic cable or a cable carrying xDSL signals as the primary interface back to Verizon's network. The MANT can be installed inside or outside of the customer's premises by the technician. The MANT can include a port to which a Verizon GSM dongle can be connected. If Verizon connects the Verizon GSM dongle to the MANT, then the MANT could communicate over the Verizon Wireless network, providing a backup network to the subscriber that would function to deliver services to the subscriber when the Verizon network services carried over the optical fiber or the DSL cable become unavailable for some reason (such as a power outage or a cut fiber). If the subscriber wants another service provider, such as AT&T Wireless, to provide the back-up network, then the subscriber would connect (or request that an AT& T technician connect) an AT&T dongle to the MANT. The MANT would then be able to communicate over the AT&T network to provide a wireless back-up network if the primary optical interface becomes unavailable. However, in this case, the subscriber has a Verizon-owned MANT connected to an AT&T device, which allows the subscriber to communicate over AT&T's network. As a result, the subscriber incurs fees from both AT&T and Verizon. Depending on the arrangement between AT&T and Verizon, the subscriber may be billed by and pay each service provider separately, or may receive bundled services and a single bill from a single service provider. In this case, the two service providers can set up a revenue sharing arrangement in which the revenue from the subscriber for the services from both service providers is shared according to some formula. It should be understood that the flow of revenue from the subscriber to the service providers is not limited to these two arrangements, and can include other such arrangements. Two different example embodiments of the provision of services from two different services providers are shown in FIGS. 3 and 4, and different example embodiments of the flow of revenues from the subscriber to the service providers and between service providers is shown in FIGS. 5 and 6.

One example embodiment of the service-providing method is shown in FIG. 3. FIG. 3 shows a first service provider 52 and a second service provider 54, although the invention is not limited to employing two service providers and can include any number of service providers providing services and employing networks and communications protocols that are the same as or different from the services, networks, and communications protocols of the service providers 52 and 54. The service providers 52 and 54 can provide communications services that are the same as or different from the services provided by the WiMAX and GPON networks shown in FIGS. 1 and 2. In addition, the service providers 52 and 54 can provide services over any of the networks according to any of the protocols discussed above in connection with FIGS. 1 and 2, but they are not limited to using those networks and communications protocols and can use any other type of network and any other type of communications protocol. In one example embodiment, the service provider 52 can provide services over an FTTP network, while the service provider 54 can provide services over a WiMAX or cellular network, although it is within the scope of the invention for the two service providers to use the same kind of network. Regardless of the type of network used, the service providers 52 and 54 can provide services by transmitting signals directly to a MANT 56, which in turn, can be configured to selectively transmit signals from the service providers 52 and 54 to one or more service termination devices 58 (only one of which is shown in FIG. 3) through which the subscriber receives the services. The MANT 56 can be the same or different from the MANTs 10 and 20 shown in FIGS. 1 and 2. The service termination devices 58 can be the same as or different from the service termination devices shown in FIGS. 1 and 2. The first service provider 52 can provide services A, B, and C directly to a user through one or more service termination devices 58 via the MANT 56. The second service provider 54 can provide services D, E, and F directly to the user through one or more service termination devices 58 via the MANT 56. These services A through F can include, but are not limited to any of wireline and wireless network access and wireline and wireless data, voice, and/or video services, such as, for example, alarm services, wireline telephone service, cellular telephone service, internet telephone service, cable television, broadcast television, direct broadcast satellite television, internet television, other internet services, and intranet services, as discussed above in connection with the embodiments shown in FIGS. 1 and 2. It is also within the scope of the invention for the first and second service providers 52 and 54 to provide more than or fewer than 3 services to the subscriber. In addition, these services A through F provided by the first and second service providers 52 and 54 can be the same as or different from each other and can be provided by the same kinds of networks using the same kinds of communications protocols, the same kinds of networks using different communications protocols, or different kinds of networks using different communications protocols.

FIG. 3 shows an example of direct rendering of services from the service providers to the subscriber. In such a direct rendering of services, service providers 52 and 54 directly provide services to the subscriber by connecting directly to the MANT 56 through their own network and separately bill the subscriber for their respective services and receive payment directly from the subscriber.

FIG. 4 shows an example embodiment of both direct and indirect rendering of services by service providers to a subscriber. More specifically, FIG. 4 shows a first service provider 60 and a second service provider 62, although the invention is not limited to employing two service providers and can include any number of service providers providing services and employing networks and communications protocols that are the same as or different from the services, networks, and communications protocols of the service providers 52 and 54. These service providers can provide communications services and employ networks and communications protocols that are the same as or different from the services, networks, and communications protocols provided by the service providers 52 and 54. In addition, these service providers can provide communications services and employ networks and communications protocols that can be the same as or different from the services, networks, and communications protocols provided by the WiMAX and GPON networks shown in FIGS. 1 and 2 and can be the same as or different from any of the other services, networks, and communications protocols mentioned above in connection with FIGS. 1-3. But it should be understood that the service providers 60 and 62 are not limited to providing the services noted above in connection with FIGS. 1-3, and are not limited to using the networks discussed above or the communication protocols discussed above in connection with FIGS. 1-3, and can provide any other services deliverable to a MANT 64 and the service termination device or devices 66 and can use any other type of network and communication protocol. For example, the service provider 60 can provide services over an FTTP network, while the service provider 62 can provide services over a WiMAX or cellular network. In the FIG. 4 example embodiment, only the service provider 60 can provide services directly to the subscriber by transmitting signals directly to a MANT 64. The service provider 62 can provide services to the subscriber only through the first service provider 60 (i.e., the first service provider's network). More specifically, in the example embodiment shown in FIG. 4, the service provider 60 can provide services A through F to the subscriber by leasing services D, E, and F from the second service provider 62. In this example embodiment, the service provider 60 can bill the subscriber for services A through F and collect the revenue from the subscriber, and can pay a leasing fee to the second service provider 62 for providing services D, E, and F. Alternatively, the second service provider 62 can provide services D, E, and F to the subscriber indirectly through the network of the first service subscriber 60, while the first service subscriber 60 can provides services A, B, and C directly to the subscriber using only its own network. In this alternative example embodiment, the service providers 60 and 62 can each bill the subscriber directly and can receive revenue directly therefrom, though the service provider 60 can charge the service provider 62 a fee for the use of its network (or the service provider 60 can provide one bill to the subscriber that includes also the charges for services from the service provider 62 and forward those revenues to the service provider 62 through a revenue sharing arrangement).

In the FIG. 4 example embodiment, the MANT 64 can be configured to selectively transmit signals from the service provider 60 (and indirectly from service provider 62) to one or more service termination devices 66 through which the subscriber receives the services A through F. The services A through F can include, but are not limited to any of wireline and wireless network access and wireline and wireless data, voice, and/or video services, such as, for example, alarm services, wireline telephone service, cellular telephone service, internet telephone service, cable television, broadcast television, direct broadcast satellite television, internet television, other internet services, and intranet services, as discussed above in connection with the embodiments shown in FIGS. 1 and 2. In addition, these services A through F provided by the first and second service providers 60 and 62 can be the same as or different from each other and can be provided by the same kinds of networks using the same kinds of communications protocols, the same kinds of networks using different communications protocols, or different kinds of networks using different communications protocols. It is within the scope of the invention for each of the first and second service providers 60 and 62 to provide more than or fewer than 3 services to the subscriber. Moreover, the MANT 64 can be the same or different from the MANTs 10, 20, and 56 shown respectively in FIGS. 1, 2, and 3. And these service termination devices 66 can be the same as or different from the service termination devices shown in FIGS. 1, 2, and 3.

FIGS. 5 and 6 show different example embodiments of business methods of exchanging funds between subscribers, and multiple service providers that provide services to the subscribers through a MANT. The types and arrangement of services provided by the service providers shown in FIGS. 5 and 6 can be the same as or different from the types of services and the means by which those services are delivered than are shown in FIGS. 1-4 and that are discussed above. In addition, the MANTs (not shown in FIGS. 5 and 6) through which the services are provided by the service providers disclosed in the example embodiments shown in FIGS. 5 and 6 can be the same as or different from the MANTs 10, 20, 56, and 64 disclosed in the embodiments of FIGS. 1-4. Also, the service termination device through which the services are provided by the service providers disclosed in the example embodiments shown in FIGS. 5 and 6 can be the same as or different from the service termination devices disclosed in the embodiments of FIGS. 1-4.

FIG. 5 shows an example embodiment in which a first service provider 68 and a second service provider 70 provide services to a subscriber 72. More specifically, the subscriber 72 receives services A, B, and C from the first service provider 68, and receives services D, E, and F from the second service provider 70. It should be understood, though, that this example embodiment is not limited to employing two service providers and can include any number of service providers providing services and employing networks and communications protocols that are the same as or different from the services, networks, and communications protocols of the service providers 52, 54, 60 and 62 shown in FIGS. 3 and 4. In one example embodiment, the subscriber 72 can receive services from each service provider 68 and 70 directly, as shown in FIG. 3, and in another example embodiment, the subscriber can receive services from the first service provider 68 directly, while receiving services from the second service provider 70 indirectly as shown in FIG. 4, or vice versa. As shown in FIG. 5, the subscriber 72 can pay a fee of $X to the first service provider 68 for services A, B, and C, and can pay a fee of $Y to the service provider 70 for services D, E, and F. The two service providers can provide separate bills to the subscriber 72 or one service provider can provide a single bill for services from both service provides, collect the revenue for the other service provider, and pay the other service provider the revenue collected for the other service provider's services (in this case it is within the scope of the invention for the other service provider to pay a billing and collection fee to the service provider collecting the revenue owed thereto). In addition, the second service provider 70, can pay a fee, $FEE, to the first service provider 68 in the event the second service provider 70 uses services of the first service provider 68 to provide services D, E, and F to the subscriber 72. For example, if the second service provider 70 provides services D, E, and F indirectly to the subscriber 72 by using the network or other infrastructure of the first service provider 68, as shown in FIG. 4, then the second service provider 70 can pay a fee, $FEE, to the first service provider 68 for the use of the first service provider's equipment.

FIG. 6 shows an example embodiment in which a first service provider 74 and a second service provider 76 provide services to a subscriber 78. More specifically, the subscriber 78 receives services A, B, and C from the first service provider 74 for a fee $X, and receives services D, E, and F from the second service provider 76 for a fee $Y. It should be understood, though, that this example embodiment is not limited to employing two service providers and can include any number of service providers providing services and employing networks and communications protocols that are the same as or different from the services, networks, and communications protocols of the service providers 52, 54, 60, 62, 68, and 70 shown in FIGS. 3-5. In one example embodiment, the subscriber 78 can receive the services from each service provider 74 and 76 directly, as shown in FIG. 3, and in another example embodiment, the subscriber 78 can receive services from the first service provider 74 directly, while receiving services from the second service provider 76 indirectly, as shown in FIG. 4, or vice versa. In the FIG. 6 embodiment, the service provider 74 can provide the subscriber 78 with a single bill for the amount $X+$Y for services A through C (costing $X) and D through F (costing $Y), the subscriber can pay the first service provider 74 the amount $X+$Y for these services, and the first service provider 74 collects the revenue $X+$Y and can pay the second service provider 76 the revenue $Y. This amount $Y, which is paid by the first service provider 74 to the second service provider 76 for providing services D, E, and F to the subscriber 78, may be increased in the event that the second service provider 76 provides services to the first service provider 74. The amount of this increase is denoted by $FEE in FIG. 6 and can vary, depending on the services provided by the second service provider 76 to the first service provider 74 and the cost of those business-to-business services. Alternatively, this amount $Y received by the second service provider 76 from the first service provider 74 may be decreased in the event that the first service provider 74 provides services to the second service provider 76. The amount of this decrease is also denoted by $FEE in FIG. 6 and can vary, depending on the services provided by the first service provider 74 to the second service provider 76 and the cost of those business-to-business services. In addition, this fee, $FEE is a net fee, incorporating all of the fees each service provider owes the other.

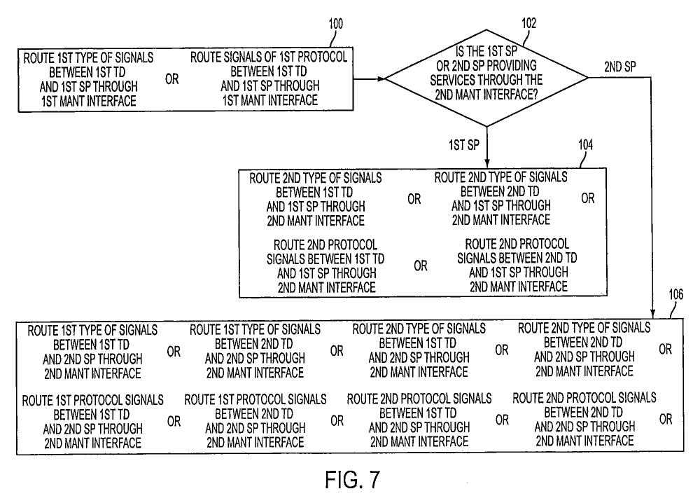

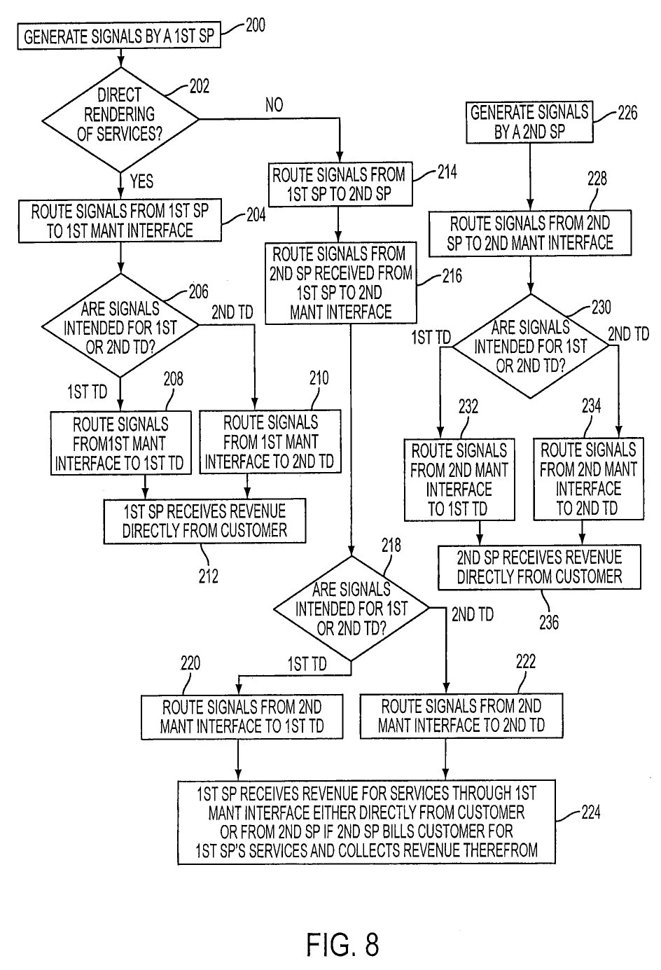

FIGS. 7 and 8 show example embodiments of methods of routing signals from different service providers (denoted in the drawings as a 1^{st} SP and a 2^{nd} SP) to a MANT and then to one or more termination devices (denoted in the drawings as 1^{st} and 2^{nd} TD's) and of managing revenues generated by the supplying of services by the service providers.

FIG. 7 shows one example embodiment of a communication method according to the invention. The method can include the routing of signals providing communication between a first termination device of a user or customer and a first service provider through a first communication interface of a MANT (block 100). The signals can be of a first type and/or the communication can follow a first type of communication protocol. This method also encompasses the routing of signals from the first service provider or a second service provider through a second communication interface of the MANT (block 102). In the event the first service provider provides services through the second communication interface of the MANT, the method can include the routing of signals providing communication between the first or a second termination device of the user and the first service provider through the second communication interface of the MANT (block 104). The signals routed through the second communication interface of the MANT can be of a second type and/or the communication through the second communication interface of the MANT can follow a second type of communication protocol. In the event a second service provider provides services through the second communication interface of the MANT, the method can include the routing of signals through the second communication interface of the MANT to provide communication between the first or second termination device of the user and the second service provider. These signals can include the first type of signal or the second type of signal for communication with the termination device and/or that uses the first type of or the second type of communications protocol for communication with the termination device (block 106). It should be understood that is within the scope of the invention 1) for the first and second service providers, the MANT, and the termination devices used in this example embodiment to be the same as or different from the service providers, the MANTs, and the termination devices discussed above in the embodiments shown in FIGS. 1-6, 2) for the first and second types of signals and protocols used in this example embodiment to be the same as or different from the signals and communications protocols discussed above in the embodiments shown in FIGS. 1-6, and 3) for the method to include more than two service providers and more than two termination devices.

FIG. 8 shows an example embodiment of a method of providing services to a user or subscriber and of managing the flow of revenue therefrom. The method can include the generating of signals by a first service provider (block 200) and the generating of signals by a second service provider (block 226). In this example embodiment, the first service provider can provide services by a direct or indirect rendering of services to the subscriber (block 202). (In contrast, as will be described below, the second service provider renders services only directly to the subscriber. But it is within the scope of the invention for the second service provider to provide services indirectly to the subscriber through another service provider, as well as directly.) In the event the first service provider renders service directly to the subscriber, signals from the first service provider are routed to a first interface of the MANT (block 204), which determines whether the signals are intended for a first or second termination device (block 206) and routes the signals to the appropriate termination device (blocks 208 and 210), and after billing the subscriber, receives revenues for the services the signals provide directly from the subscriber (block 212). In the event the first service provider renders service indirectly to the subscriber, signals from the first service provider are routed to a second service provider that has a direct connection to the MANT (block 214). The second service provider routes the signals received from the first service provider to a second interface of the MANT to which the second service provider is connected to transmit signals therefrom (block 216). The MANT determines whether these signals are intended for the first or second termination device (block 218) and routes the signals to the appropriate termination device (blocks 220 and 222). Thereafter, either the first service provider bills the subscriber directly and receives revenue directly therefrom, or the second service provider bills the subscriber for the services of the first service provider, collects the revenue, and distributes that revenue to the first service provider (block 224). In this latter case, the second service provider can charge the first service provider a fee for the use of its network and/or equipment. In an alternative embodiment, the second service provider may lease services from the first service provider for a fee and provide those services directly to the subscriber, and then bill, collect, and keep the revenues therefrom. The signals generated by the second service provider that do not originate with the first service provider (block 226) are also routed to the second interface of the MANT (block 228). The MANT then determines whether these signals are intended for the first or second termination device (block 230) and routes the signals to the appropriate termination device (blocks 232 and 234), and after billing the subscriber, receives revenues for the services the signals provide directly from the subscriber (block 236). It should be understood that is within the scope of the invention 1) for the first and second service providers, the MANT, and the termination devices used in this example embodiment to be the same as or different from the service providers, the MANTs, and the termination devices discussed above in the embodiments shown in FIGS. 1-6, 2) for the types of signals and protocols used by the service providers to provide services through the MANT in this example embodiment to be the same as or different from the signals and communications protocols discussed above in the embodiments shown in FIGS. 1-6, and 3) for the method to include more than two service providers and more than two termination devices.

The service-provider revenue sharing arrangement of the embodiments shown in FIGS. 5 and 6, the configuring of the MANTs shown in FIGS. I through 5, and the instructing of the performing of various functions by the various networks to which the MANTs of FIGS. I through 6 are connected, may be provided as a software embodiment comprising a software computer program or a computer program product, that may include but is not limited to an article of manufacture on a machine accessible or machine readable medium having instructions. The instructions on the machine accessible or machine-readable medium may be used to program a computer system or other electronic device. The machine-readable medium may include, but is not limited to, floppy diskettes, optical disks, CD-ROMs, and magneto-optical disks or other type of media/machine-readable medium suitable for storing or transmitting electronic instructions. The techniques described herein are not limited to any particular software configuration. They may find applicability in any computing or processing environment. The terms “machine accessible medium” or “machine readable medium” used herein shall include any medium that is capable of storing, encoding, or transmitting a sequence of instructions for execution by the machine and that cause the machine to perform any one of the methods described herein. Furthermore, it is common in the art to speak of software, in one form or another (e.g., program, procedure, process, application, module, unit, logic, and so on) as taking an action or causing a result. Such expressions are merely a shorthand way of stating that the execution of the software by a processing system causes the processor to perform an action to produce a result.

While the invention has been particularly shown and described with respect to various embodiments thereof, it should be understood that the embodiments have been presented by way of example, and not limitation. It will be apparent to persons skilled in the relevant art(s) that various changes in form and detail can be made therein in a computer program product or software, hardware or any combination thereof, without departing from the broader spirit and scope of the invention. Thus, the invention should not be limited by any above-described examples of embodiments of the invention, but should be defined only in accordance with the following claims and their equivalents.

In addition, it should be understood that the figures, which highlight the functionality and advantages of the invention, are presented for example purposes only. The architecture of the invention is sufficiently flexible and configurable, such that it may be utilized (and navigated) in ways other than that shown in the accompanying figures.

Furthermore, the purpose of the foregoing Abstract is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. The Abstract is not intended to be limiting as to the scope of the invention in any way. It is also to be understood that the steps and processes recited in the claims need not be performed in the order presented.

What is claimed is:

1. A multi-access network terminal comprising:
a first communication interface configured to communicate with a first service provider providing services to a user through the first communication interface with a first type of signal and/or a first type of communications protocol; and
a second communication interface configured to communicate with either the first service provider providing services to the user through the second communication interface using a second type of signal and/or a second type of communications protocol or a second service provider providing services to the user through the second communication interface using the first or second type of signal and/or the first or second different type of communications protocol.

2. The multi-access network terminal according to claim 1, wherein the first type of signal is a wireline signal transmittable over an optical or electrical cable, and the second type of signal is a wireless signal, or the second type of signal is a wireline signal transmittable over an optical or electrical cable, and the first type of signal is a wireless signal.

3. The multi-access network terminal according to claim 2, wherein the wireline signal is one of a wavelength division multiplexed optical signal, a dense wavelength division multiplexed optical signal, and an electrical signal comprising one of a cable modem signal, an analog telephone signal, and an xDSL signal, and the wireless signal is one of a WiMAX signal, a WiFi signal, a cellular phone signal, a direct broadcast satellite signal, and a femtocell signal.

4. The multi-access network terminal according to claim 1, wherein both the first and second types of signals are wireline signals of different types or wireless signals of different types.

5. The multi-access network terminal according to claim 1, further comprising:
a plurality of ports, each connectable to a service termination device, comprising at least two of a 10/100/1000Base-T port, a universal MoCA/HPNA MAC port, a WiFi port, a USB port, a Firewire port, an IPTV port, a home-alarm port connectable to an alarm system, a voice port comprising at least one of a local analog POTS port and a cellular phone port communicating with a cellular telephone via a femtocell protocol, and an analog RF video port.

6. A multi-access network terminal connectable to multiple service termination devices provided in a particular location comprising:
a first communication interface configured to connect with at least one of the service termination devices provided in the particular location and to communicate with a first service provider providing services to the service termination device connected to the first communication interface; and
a second communication interface configured to connect with the same or a different one of the service termination devices and to communicate with a second service provider providing services to the service termination device connected to the second communication interface.

7. The multi-access network terminal according to claim 6,
wherein the first communication interface is configured to receive a first type of signal transmitted according to a first communication protocol from the first service provider for the service termination device, and
wherein the second communication interface is configured to receive either the first type of signal transmitted according to the first communication protocol or a second communication protocol from the second service provider for the same or a different service termination device in the particular location, or to receive a second type of signal transmitted according to a third communication protocol from the second service provider for the same or a different service termination device.

8. The multi-access network terminal according to claim 7,
wherein the first type of signal is a wireline signal transmittable over an optical or electrical cable, and the second type of signal is a wireless signal, or the second type of signal is a wireline signal transmittable over an optical or electrical cable, and the first type of signal is a wireless signal.

9. The multi-access network terminal according to claim 8,
wherein the wireline signal is one of a wavelength division multiplexed optical signal, a dense wavelength division multiplexed optical signal, and an electrical signal comprising one of a cable modem signal, an analog telephone signal, and an xDSL signal, and the wireless signal is one of a WiMAX signal, a WiFi signal, a cellular phone signal, a direct broadcast satellite signal, and a femtocell signal.

10. The multi-access network terminal according to claim 7,
wherein both the first and second types of signals are wireline signals of different types or are wireless signals of different types.

11. The multi-access network terminal according to claim 6, further comprising:
a plurality of ports, each connectable to a service termination device, comprising at least two of a 10/100/1000Base-T port, a universal MoCA/HPNA MAC port, a WiFi port, a cellular port, a USB port, a Firewire port, an IPTV port, a home-alarm port connectable to an alarm system, a voice port comprising at least one of a local analog POTS port and a cellular phone port communicating with a service termination device via a femtocell protocol, and an analog RF video port.

12. A communication method comprising:
routing signals providing communication between at least one termination device of a user and a first service provider through a first communication interface of a multi-access network terminal, the signals being of a first type and/or the communication following a first type of communication protocol; and
performing at least one of:
routing signals providing communication between at least the same or a different termination device of the user and the first service provider through a second communication interface of the multi-access network terminal, the signals routed through the second communication interface being of a second type and/or the communication through the second communication interface following a second type of communication protocol; and
routing signals through the second communication interface providing communication between the same or a different termination device of the user and a second service provider that uses the first type of signal or the second type of signal for communication with the termination device and/or that uses the first type of or the second type of communications protocol for communication with the termination device.

13. A communication method according to claim 12,
wherein the first type of signal is a wireline signal transmitted over an optical or electrical cable, and the second type of signal is a wireless signal, or the second type of signal is a wireline signal transmitted over an optical or electrical cable, and the first type of signal is a wireless signal.

14. The communication method according to claim 13,
wherein the wireline signal is one of a wavelength division multiplexed optical signal, a dense wavelength division multiplexed optical signal, and an electrical signal comprising one of a cable modem signal, an analog telephone signal, and an xDSL signal, and the wireless signal is one of a WiMAX signal, a WiFi signal, a cellular phone signal, a direct broadcast satellite signal, and a femtocell signal.

15. The communication method according to claim 13, wherein both the first and second types of signals are wireline signals of different types or wireless signals of different types.

16. A method of providing services to a user comprising:
generating signals by a first service provider for transmission to a service termination device of a user; and
routing the signals from the first service provider to the service termination device through a multi-access network terminal through which a second service provider transmits signals to the same or a different service termination device of the user.

17. The method according to claim 16, wherein the signal routing is performed by transmitting the signals from the first service provider to a different interface of the multi-access network terminal from the interface of the multi-access network terminal receiving the signals from the second service provider.

18. The method according to claim 16, wherein the signal routing is performed by transmitting the signals from the first service provider to the same interface of the multi-access network terminal as the interface of the multi-access network terminal receiving the signals from the second service provider.

19. The method according the claim 18, wherein the signal routing is performed by transmitting the signals from the first service provider to the second service provider, which transmits the signals from the first service provider to the same interface of the multi-access network terminal as the other signals from the second service provider.

20. The method according to claim 16, further comprising:
receiving signals, by the first service provider, from the second service provider for transmission to a designated service termination device of a user; and
transmitting the signals received from the second service provider by the first service provider to the multi-access network terminal for distribution to the designated service termination device.

21. The method according to claim 16, wherein the services from the two service providers are the same or different from each other.

22. A method of managing the flow of revenue for services rendered by a service provider through a multi-access network terminal comprising:
routing signals from a first service provider to a service termination device of a user through the multi-access network terminal through which a second service provider transmits signals to the same or a different service termination device of the user; and
receiving by the first service provider a first revenue from the user for services rendered by the first service provider through the multi-access network terminal.

23. The method according to claim 22, further comprising:
routing the signals from the first service provider directly to an interface of the multi-access network terminal; and
receiving by the first service provider the first revenue directly from the user.

24. The method according to claim 22, further comprising:
providing the services from the first service provider by sending signals from the first service provider to the service termination device through the second service provider, which sends signals directly to the multi-access network terminal; and
receiving, by the first service provider, the first revenue, from the second service provider, which bills the user for services from the first service provider, collects the first revenue, and pays the first service provider the first revenue.

25. The method according to claim 24, further comprising paying, by the first service provider, the second service provider for transmitting the signals from the first service provider to the multi-access network terminal.

26. The method according to claim 22, further comprising:
receiving, by the first service provider, signals from the second service provider that provide services to the same or a different service termination device of the user;
transmitting, by the first service provider, the signals from the second service provider to the multi-access network terminal, for distribution from the multi-access network terminal to the service termination device of the user to which the second service provider is providing services; and
receiving, by the first service provider, revenue from the second service provider for services rendered in connection with transmitting the signals from the second service provider to the multi-access network terminal.
